(19) United States
(12) Patent Application Publication
(10) Pub. No.: US 2002/0153430 A1
(43) Pub. Date: Oct. 24, 2002

(54) Hydraulic lift translation system

(76) Inventor: Patrick Mattes, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 09/958,019

(22) PCT Filed: Jan. 23, 2001
(86) PCT No.: PCT/DE01/00255

(30) Foreign Application Priority Data
Feb. 4, 2000 (DE) 100 04 810.2

(51) Int. Cl. F02M 47/02

(52) U.S. Cl. 239/88

(57) ABSTRACT

In a hydraulic stroke step-up system, in particular for an injection nozzle of a fuel injection system, having a base body (10), an inlet piston (24), a coupling chamber (38) which is filled with a hydraulic fluid, and an outlet piston (14), reliable ventilation of the coupling chamber on the one hand and a loss-free conversion of a motion of the inlet piston into a motion of the outlet piston on the other are to be assured. To this end, an intermediate piston (20) is provided, which is displaceable between a position of repose, in which the coupling chamber is closed from the outside by a ventilation opening (40), and a working position in which the ventilation opening and thus the coupling chamber are closed.

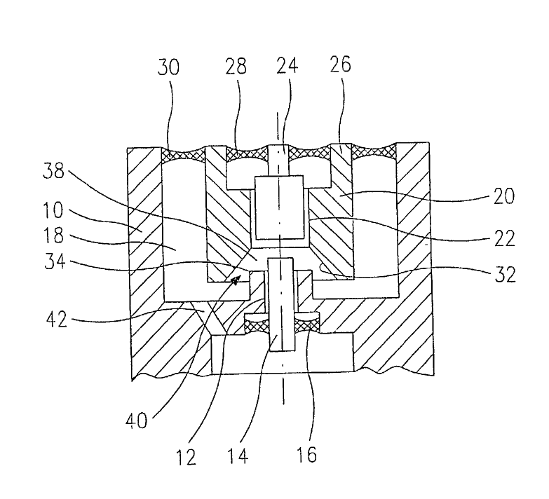

### PRIOR ART

The invention relates to a hydraulic stroke step-up system, in particular for an injection nozzle of a fuel injection system, having a base body, an inlet piston, a coupling chamber which is filled with a hydraulic fluid, and an outlet piston.

The stroke step-up system serves to step-up a short stroke of the inlet piston to a longer stroke of the outlet piston. The necessity of such a step-up arises especially whenever the inlet piston is actuated by a piezoelectric actuator. When a control voltage is applied to a piezoelectric actuator, the piezoelectric actuator generates only a very short stroke, on the order of magnitude of approximately 1.2 thousandths of its total length. If this short stroke is to be used to control the opening and closing of a nozzle needle of a fuel injection valve, for instance, the stroke of the inlet piston is stepped up to a longer stroke of the outlet piston. By the choice of the ratio of the cross section of the outlet piston to the cross section of the inlet piston, the step-up factor can be adjusted in a suitable way.

In addition to the step-up function, the hydraulic stroke step-up system has the function of length compensation. The individual piezoelectric elements used in the piezoelectric actuator in fact have a comparatively major change in length upon a temperature change. To prevent this change in length from leading to a change in the switching characteristic of the injection valve, a compensation for the change in length must be possible. In the hydraulic stroke step-up systems known until now, to compensate for the change in length of the piezoelectric actuator a comparatively great guide play was used around the inlet piston and/or the outlet piston. The annular gap formed in this way serves both to fill the coupling chamber that is present between the inlet piston and the outlet piston and to provide sealing. The guide play must be adapted such that on the one hand, a comparatively slow displacement of volume out of or into the coupling chamber is possible, while on the other, upon a faster volumetric displacement, an adequate flow resistance is presented. The slow volumetric displacement is necessary in order to fill the coupling chamber with the hydraulic fluid. Upon a change in length of the piezoelectric actuator as well, with the attendant displacement of the inlet piston, the hydraulic fluid present in the coupling chamber must be capable of escaping from the coupling chamber or flowing into it for replenishment purposes. The high flow resistance that is supposed to be operative upon a rapid subjection of the coupling chamber to pressure is necessary to attain the desired adjustment of the outlet piston upon an actuation of the inlet piston by the piezoelectric actuator. In other words, the hydraulic system formed by the two pistons and the coupling chamber must not have any flow losses from the guide play in the event of a rapid actuation of the inlet piston. In practice, however, it entails very great effort to adjust the guide play in such a way that the coupling chamber functions as desired. Especially in the event that there is air in the coupling chamber, secure function cannot be assured.

The object of the invention is to further develop a hydraulic stroke step-up system of the type defined at the outset such that with greater functional security, both filling of the coupling chamber in the state of repose of the hydraulic stroke step-up system and loss-free conversion of a motion of the inlet piston into a motion of the outlet piston upon an activation of the stroke step-up system are possible.

### ADVANTAGES OF THE INVENTION

A hydraulic stroke step-up system having the characteristics of claim 1 has two different states, each serving a different function. In a first state, in which the intermediate piston is in the position of repose, the coupling chamber can be well filled by the ventilation opening that then exists. Also then, good venting of the coupling chamber is possible, resulting in high stiffness of the system. The reliable ventilation also assures that the inlet piston will contact the piezoelectric actuator at all times, since major underpressures in the coupling chamber are prevented. It is also readily possible to compensate for a change in length caused by temperature factors, since the requisite volumetric displacement can be effected without problems through the ventilation opening. In a second state, in which the intermediate piston is in the working position, the ventilation opening is closed, so that the coupling chamber has no leakage upon a step-up of the motion of the inlet piston to a motion of the outlet piston. Overall, improved performance of the stroke step-up system is obtained, since there is no longer a need to seek a compromise, by the suitable dimensioning of the various components, between the two contradictory functions of ventilating the coupling chamber and sealing off the coupling chamber in fluid-tight fashion.

Advantageous features of the invention will become apparent from the dependent claims.

### DRAWING

The invention is described below with reference to a preferred embodiment, which is shown in the accompanying sole drawing. In the drawing, a hydraulic stroke step-up system according to the invention is shown in cross section.

### DESCRIPTION OF THE EXEMPLARY EMBODIMENT

The hydraulic stroke step-up system of the invention has a base body 10, which is provided with a guide 12 for an outlet piston 14. The outlet piston 14 is connected to the base body 10 by a rubber ring spring 16.

The base body 10 has a recess 18, in which an intermediate piston 20 is disposed. The intermediate piston 20 is provided with a guide 22, in which an inlet piston 24 is supported displaceably.

The gap between the guide 22 in the intermediate piston 20 and the inlet piston 24, and the gap between the guide 12 in the base body 10 and the outlet piston 14, are each on the order of magnitude of 2 micrometers.

The intermediate piston 20 is provided with an annular collar 26, in whose interior a rubber ring spring 28 is disposed. With its radially inner edge, the rubber ring spring 28 engages the inlet piston 24. Between the base body 10 and the intermediate piston 20, a third rubber ring spring 30 is provided, which with its radially inner edge rests on the collar 26 of the intermediate piston and with its radially outer edge rests in the interior of the recess 18. The stiffness of the rubber ring spring 28 is greater than the stiffness of the rubber ring spring 30.

The intermediate piston 20, on its side toward the outlet piston 14, is provided with a frustoconical sealing face 32, which is concentric with the longitudinal axis of the inlet piston 24. Associated with the sealing face 32 is a sealing seat 34, which is formed as an encompassing edge on a cylindrical protrusion 36 of the base body 10.

The structure described thus far is entirely rotationally symmetrical.

Between the inlet piston 24 and the outlet piston 14, inside the intermediate piston 20, a coupling chamber 38 is formed, which in the position of repose, shown in the drawing, of the stroke step-up system communicates with the recess 18 in the base body through a ventilation opening 40, which is formed as an annular gap between the sealing face 32 and the sealing seat 34. A rising bore 42 leads to the recess 18 and supplies the recess 18 and thus also the coupling chamber 38 with a hydraulic fluid. Since in the position of repose, shown in the drawing, of the system the ventilation opening 40 has a relatively large cross section, it is assured that the coupling chamber 38 is always correctly filled with the hydraulic fluid.

When the inlet piston 24 is actuated downward in terms of the drawing, the intermediate piston 20 is simultaneously carried along with it, since the stiffness of the rubber ring spring 28 that acts between the inlet piston 24 and the intermediate piston 20 is greater than the stiffness of the rubber ring spring 30 that acts between the intermediate piston 20 and the base body 10. As a result of the adjustment, the intermediate piston 20 comes with its sealing face 32 to rest on the sealing seat 34, so that the annular gap between the sealing face and the sealing seat is closed, and the coupling chamber 38 with the hydraulic fluid enclosed in it is tightly sealed off. When the inlet piston 24 is now adjusted onward in the direction toward the outlet piston 14, this stroke is stepped up, by means of the hydraulic fluid enclosed in the coupling chamber 38, to a stroke of the outlet piston 14. Since the inlet piston 24 has a larger cross section than the outlet piston 14, the result is an increase in the length of the stroke of the outlet piston, compared to the stroke of the inlet piston.

When the inlet piston 24 is retracted again, the annular gap between the sealing face 32 and the sealing seat 34 opens again, so that the coupling chamber 38 can again be filled with hydraulic fluid through the ventilation opening.

1. A hydraulic stroke step-up system, in particular for an injection nozzle of a fuel injection system, having a base body (10), an inlet piston (24), a coupling chamber (38) which is filled with a hydraulic fluid, and an outlet piston (14),
characterized in that an intermediate piston (20) is provided, which is displaceable between a position of repose, in which the coupling chamber is closed from the outside by a ventilation opening (40), and a working position in which the ventilation opening and thus the coupling chamber are closed.

2. The hydraulic stroke step-up system of claim 1, characterized in that the intermediate piston (20) is provided with a guide (22) for the inlet piston (24), and the base body (10) is provided with a guide (12) for the outlet piston (14).

3. The hydraulic stroke step-up system of claim 2, characterized in that between the guide (22) for the inlet piston and the inlet piston (24) itself, there is play on the order of magnitude of 2 micrometers.

4. The hydraulic stroke step-up system of one of claims 2 and 3, characterized in that between the guide (12) for the outlet piston and the outlet piston (14) itself, there is play on the order of magnitude of 2 micrometers.

5. The hydraulic stroke step-up system of one of the foregoing claims, characterized in that the intermediate piston (20) is provided with a sealing face (32), and the base body (10) is provided with a sealing seat (34) for the sealing face, and that the ventilation opening (40) is formed by an annular gap, which is formed between the sealing face and the sealing seat in the outset position of the intermediate piston (20).

6. The hydraulic stroke step-up system of one of the foregoing claims, characterized in that the intermediate piston (20) is connected to the inlet piston (24) by a spring (28).

7. The hydraulic stroke step-up system of one of the foregoing claims, characterized in that the intermediate piston (20) is connected to the base body (10) by a spring (30).

8. The hydraulic stroke step-up system of one of the foregoing claims, characterized in that the outlet piston (14) is connected to the base body (10) by a spring (16).

9. The hydraulic stroke step-up system of one of claims 6-8, characterized in that the spring (16; 28; 30) is formed by a rubber ring spring.

10. The hydraulic stroke step-up system of claims 6 and 7, characterized in that the stiffness of the spring (28) that is disposed between the inlet piston and the intermediate piston is greater than the stiffness of the spring (30) that is disposed between the intermediate piston and the base body.
